(19) United States
(12) Patent Application Publication
(10) Pub. No.: US 2008/0073156 A1
(43) Pub. Date: Mar. 27, 2008

(54) BELT FOR AN ELEVATOR INSTALLATION, PRODUCTION METHOD FOR SUCH A BELT AND ELEVATOR INSTALLATION WITH SUCH A BELT

(76) Inventor: Ernst Ach, Ebikon (CH)

Correspondence Address: FRASER CLEMENS MARTIN & MILLER LLC, 28366 KENSINGTON LANE, PERRYSBURG, OH, 43551, US

(21) Appl. No.: 11/836,438

(22) Filed: Aug. 9, 2007

Related U.S. Application Data
(60) Provisional application No. 60/822,141, filed on Aug. 11, 2006.

(30) Foreign Application Priority Data
Aug. 11, 2006 (EP) 06118819.9

(51) Int. Cl. B66B 7/00; B29D 29/00

(52) U.S. Cl. 187/250; 474/238

(57) ABSTRACT

A belt (12) for a lift installation comprises a first part belt (13) of a first material, a tensile carrier arrangement with at least one tensile carrier (14), which is arranged in the first part belt, and a second part belt (15) of a second material. The first material comprises a thermoplastic plastics material for acceptance and distribution of the local area pressures introduced into the belt by the tensile carriers.

The present invention relates to a belt for a for a lift installation, a production method for such a belt and a lift installation with such a belt.

A lift installation comprises a lift cage and usually a counterweight, the cage and counterweight being movable in a lift shaft or along free-standing guide devices. For producing the movement the lift installation comprises at least one drive unit with at least one drive pulley, which carry the lift cage and the counterweight by way of one or more belts and/or transmit the required drive forces thereto.

In that case the lift cage and the counterweight can be connected by way of the same belts, which are guided over the drive pulley or pulleys and act not only as support means, but also as drive means. Alternatively, the lift cage and the counterweight can also be carried by way of separate support belts and driven by way of separate drive belts.

A belt according to the present invention can be used for each of the above-described functions, thus as a combined drive and support belt, as a support belt which runs over at least one deflecting pulley (support roller) and connects the lift cage with the counterweight and carries both, or as a drive belt which has exclusively a drive function and runs over at least one drive pulley.

Such belts for lift installations usually comprise a belt body consisting of an elastomer. In order to transmit the tensile forces, tensile carriers in the from of steel and/or synthetic material cords are embedded in the belt body. The cords can be constructed as, for example, strands or cables of steel wires or synthetic material fibres. They are advantageously arranged in the neutral axis of the belt cross-section in which no tensile or compressive stresses arise in looping round of a belt pulley.

A lift installation according to category is known from EP 1 555 234 B1 in which the belt has on a traction side facing the drive wheel a rib arrangement with several wedge-shaped ribs, which extend in longitudinal direction of the belt and which engage in corresponding grooves on the drive wheel. Due to the fact that the contact between the belt and the drive wheel takes place by way of the inclined flanks of the wedge-shaped ribs or grooves, the pressing forces between the belt and the drive wheel and thus the traction capability or drive capability increase for the same radial force and consequently the same bearing loading and belt tension. At the same time the wedge ribs advantageously guide the belt on the drive wheel in transverse direction. Since the belts contain tensile carriers with relatively small diameters, it is possible to use drive wheels and deflecting wheels with correspondingly small diameters. For example, the drive output shaft of the drive unit can itself also be constructed as drive wheel.

In the following there is therefore consistent reference to drive wheels which comprise conventional drive pulleys with larger diameters, but also drive pulleys with relatively small diameters and, in particular, also drive output shafts of a drive unit of a lift installation. Where in the following statements refer not only to drive wheels, but also to deflecting wheels, these are designated in common as belt wheels.

The use of belts with thin tensile carriers and of belt wheels with small diameters has the consequence of high area pressures between the individual tensile carriers and the belt bodies surrounding them, as also high compressive and shear stresses in the belt body itself. The area pressure and/or the said stresses in the belt body can attain values at which the risk of damage of the belt body is given.

This risk is greater the smaller the diameter of the tensile carriers, since as a consequence of the reduction in the force-transmitting surface for the same belt loading the area pressure as also the stresses caused by the tensile carriers increase in the belt body. In addition, the notch effect on the belt body is amplified with reducing tensile carrier diameter, which belt body—with respect to the requisite friction between belt and drive wheel, the requisite transmission of tensile forces from the belt body to the tensile carriers and the desired damping of oscillations or the absorption of shocks in the belt—is usually made of a relatively soft elastomer and thus is particularly susceptible relative to the mentioned loads.

Since the deflection about the belt wheels and the transmission of the tensile force from a drive wheel to the individual tensile carriers takes place under shear and/or tensile deformation of the belt body there is a possibility, due to the above-illustrated effects, of damage to the belt body in the form of abrasion and/or shattering of the elastomer surrounding the tensile carriers and/or cutting of tensile carriers into the elastomer.

This risk also exists with belts according to the introductory part of claim 1, such as are known from U.S. Pat. No. 7,037,578 B2 and DE 694 01 784 T2. There, too, the tensile carriers are embedded in a matrix of the soft elastomer, particularly polyurethane (PU), polychloroprene (CR) or ethylene-propylene-diene rubber (EPDM).

Thus, such belts cannot be used, or can be used only conditionally, in safety-sensitive devices such as a lift installation, since here the risk potential in the case of belt breakage due to the above-described damage is too high. Equally, such belts cannot be used for transmission of high forces, since in that case the risk of such damage is increased.

An object of the present invention is therefore to create a lift installation in which the risk of failure due to belt breakage is reduced. A further object of the present invention is to provide a belt for such a lift installation which can transmit even higher forces. A further object of the present invention is to indicate a method for producing such a belt.

For fulfilment of these objects a belt according to the introductory part of claim 1, a production method according to the introductory part of claim 7 and a lift installation according to the introductory part of claim 7 are developed by the characterising features thereof.

A belt for a lift installation according to an embodiment of the present invention comprises a first part belt of a first material, in which a tensile carrier arrangement with at least one tensile carrier of steel wire or of steel wire strands or steel wire cables is arranged, and a second part belt of a second material different from the first material.

According to the invention the first material comprises at least one thermoplastic plastics material. Preferably this thermoplastic plastics material is polyamide (PA), polyethylene (PE), polycarbonate (PC) or polyvinylchloride (PVC). Equally, the first material can also comprises a mixture of two or more thermoplastic plastic materials, a so-termed polyblend. The first material can, for strengthening, also contain additives, particularly fibres such as, for example, carbon fibres or glass fibres. Equally, the first material can comprise a fabric consisting of a thermoplastic plastics material.

Through the arrangement of the tensile carrier arrangement in the first part belt consisting of a first thermoplastic material this first material, which is particularly suitable for the purpose, accepts the forces acting normally and tangentially to the surface of the tensile carriers and transmits these, distributed over substantially the entire connecting area, to the second part belt. The area over which the forces from the tensile carriers are introduced into the second part belt thereby increases so that the stresses, particularly compressive and shear stresses, acting thereon reduce. At the same time the notch effect on the second part belt reduces.

Advantageously it is thus possible to select the second material of the second part belt with respect to the function thereof, particularly the friction-locking contact with a drive wheel, damping of oscillations and shocks and/or the elasticity required for looping around belt wheels. At the same time, the forces to be transmitted by the tensile carriers and thus the permissible belt loading can be increased, since the area pressures and stresses produced by the tensile carriers in the belt are initially accepted by the first part belt, the first material of which can be selected to be suitable with respect to the load which is present. The loads transmitted by the tensile carriers to the belt body can be distributed in the first part belt so that the maximum area pressures and compressive stresses acting on the second part belt at the connecting surface thereof relative to the first part belt occur only to reduced extent.

Preferably the first part belt is formed to be comparatively thin so that notwithstanding its greater hardness it does not significantly impair the elasticity of the belt in bending. Advantageously the thickness of the first part belt accordingly amounts to at most 60%, preferably at most 40% and particularly preferably at most 30%, of the total thickness of the belt.

In order to ensure that the first material of which the first part belt consists withstands over the long term the relatively high local area pressures, compressive stresses and shear stresses resulting from the loading of the tensile carriers the first material preferably has the following material characteristic values (at room temperature):

| | |
|---|---|
| minimum yield stress according to DIN 53455 or ISO 527: | 45 N/mm² |
| minimum elongation at tear according to DIN 53455 | 45% |
| or ISO 527: | |
| minimum indentation hardness according to DIN 53456 | 30 N/mm² |
| or ISO 2039 (H358/30s): | |
| preferably: | 50 N/mm² |
| particularly preferably: | 70 N/mm² |

In materials with these characteristic values the tensile carriers do not cut in or cut in only slightly even under high load. They also withstand the compressive and/or shear stresses, which occur, without exhibiting impermissibly high deformations, abrasion or shattering.

The coefficient of friction of the first material which also forms the belt back remote from the traction surface, is preferably also relatively small. The friction force which arises between the deflecting wheels and the belt and which has to be overcome for lateral guidance of the belt on the deflecting wheel thereby reduces during looping around deflecting wheels without longitudinal grooves. As a consequence, the harmful lateral frictional loading of the belt—for example by guide flanges of the deflecting wheels—and thus also the required drive power of the lift installation are reduced and the service life of the belt increased.

In an advantageous embodiment a belt according to the present invention can have for this purpose a coating of the belt rear side from a material which has a lower coefficient of friction and/or a higher abrasion resistance than the first material.

The tensile carrier arrangement comprises at least one, but preferably several, substantially parallel tensile carriers, which can be arranged, in particular, in the longitudinal direction of the belt. The arrangement of the tensile carriers in accordance with the invention in the stable first part belt facilitates positionally correct arrangement thereof during the production process, since the tensile carriers are already fixed in the first material on application of the second material. The tensile carriers can be constructed as a single wire or, preferably, built up from strands or cables, wherein the strands or cables are made of steel wires. In a particularly preferred construction the tensile carriers of the tensile carrier arrangement are arranged in or in the vicinity of the neutral axis of the entire belt, in which axis no tensile or compressive stresses occur on deflection around a belt wheel, particularly a drive wheel.

The second part belt of the belt is preferably provided for co-operation with a drive wheel of the lift installation. In an advantageous embodiment it has for this purpose a traction surface in which at least one wedge rib is formed, which rib engages in a corresponding, substantially complementary groove in the running surface of the drive wheel. Preferably several wedge ribs can be formed adjacent to one another for increasing the traction capability or for improving the lateral guidance of the belt on the belt wheels. These ribs do not necessarily have to be connected together. Separate wedge ribs, which are arranged on the first part belt, of the second part belt can advantageously provide compensation for positional deviations of the individual grooves of a drive wheel relative to one another. On the other hand, an at least thinner connecting web, which extends between adjacent ribs on the connecting surface to the first part belt, advantageously increases this connecting surface and thus the strength of the connection between the first and the second part belt.

In an advantageous embodiment a wedge rib has a substantially trapezium-shaped cross-section with a flank angle, as measured between its two flanks, of 600 to 1200. Other cross-sectional shapes, for example triangular cross-sections, are also possible.

In an advantageous embodiment the traction surface of the belt has a coating which has a defined coefficient of friction with the running surface of a drive wheel of the lift installation. This coefficient of friction can be higher than that of the second material so as, for example, to improve the traction capability. Alternatively, it can also be lower than that of the second material. This reduces, on the one hand, the wear at the traction surface and can eliminate, particularly in the case of a traction surface on which one or more wedge ribs are formed, the risk of jamming of the wedge ribs in the grooves of a belt wheel.

The second material for the second part belt preferably comprises an elastomer, particularly polyurethane, polychloroprene or ethylene-propylene-diene rubber, or a mixture of two or more elastomers. An elastomer of that kind of the second part belt is sufficiently flexible for looping around belt wheels with smaller diameters. At the same time, such a second material in known manner advantageously damps oscillations and shocks in the belt. At the same time it withstands, during co-operation with a running surface of a drive wheel, the shear deformation, which arises in the belt for transmission of the tensile forces, due to its elastic characteristics.

It is thus possible to select for the second part belt a relatively soft second material having a hardness at room temperature advantageously less than 95 Shore (A), preferably less than 90 Shore (A) and particularly preferably less than 85 Shore (A), since in accordance with the invention the high local area pressures of the individual tensile carriers are absorbed by the first, harder material and transmitted to the second material as a more homogeneous and lesser area pressure over the connecting surface.

A belt according to one embodiment of the present invention is preferably produced in the following steps. Initially the first part belt is made from the first material. Advantageously this is carried out by extruding the thermoplastic plastics material, which makes possible a uniform, economic and uninterrupted production.

The tensile carriers can be arranged in the first part belt already during primary forming (extrusion process) of the first part belt, for which purpose the individual tensile carriers are fed, during the extrusion process, to the first part belt, which arises, in such a manner that they are completely encased by the first material at least on the side facing the second part belt.

The tensile carriers are preferably completely encased by the first material. For fulfilment of the object according to the invention it is, however, sufficient if the side of the tensile carriers facing the second part belt is separated therefrom by the first material. In a further form of embodiment of the present invention the first part belt can therefore be produced initially and subsequently the individual tensile carriers arranged on the side thereof remote from the connecting surface to the second part belt. For this purpose the first part belt can advantageously have, on this remote side, grooves for positionally correct positioning of the tensile carriers. The fixing of the tensile carriers in the grooves of the first part belt can in that case be carried out by means of thermal subsequent processing of the thermoplastic material or through addition of an adhesive. The tensile carriers which are arranged in the region of the side of the first part belt remote from the second part belt can, however, also be fixed at the second part belt by a third part belt which is connected with the said side of the first part belt, for example by gluing and/or extrusion on, in such a manner that the tensile carriers are fixed between first and third part belts.

In a further step the second part belt is produced from the second material and fixedly connected with the first part belt. This can preferably take place by extrusion of the second part belt onto the first part belt. In that case the wedge ribs of the traction surface of the second part belt can also be advantageously formed.

Equally, the second part belt can also be glued to the first part belt. In a particularly preferred embodiment the second material contains for this purpose an adhesive which at the time of extrusion onto the first part belt creates a fixed connection therewith by thermal adhesion.

The advantageous coating of the traction surface of the second part belt can be coated thereon during its production or subsequently. Thus, a synthetic fibre fabric, a layer of another elastomer, a flock layer and/or a thermoplastic layer, which, for example, contains polyamide, can be arranged on the traction surface of the second part belt during extrusion thereof, wherein the coating advantageously fixedly connects with the still formable second material.

A lift installation according to the present invention comprises a lift cage, a drive unit with at least one drive wheel and a belt arrangement with at least one belt according to an embodiment of the present invention. Advantageously the belt arrangement can also comprise several belts according to one or various embodiments of the present invention, which can be fixedly or releasably connected together in, for example, mechanically positive manner. This makes it possible to compose a relatively wide belt arrangement from several narrower belts, which are easier to handle, in situ. The drive wheel or the drive wheels has or have in a preferred embodiment a wedge rib profile substantially complementary to the traction surface of the second belt.

Further objects, features and advantages are evident from the subclaims and the examples of embodiment described in the following. For this purpose:

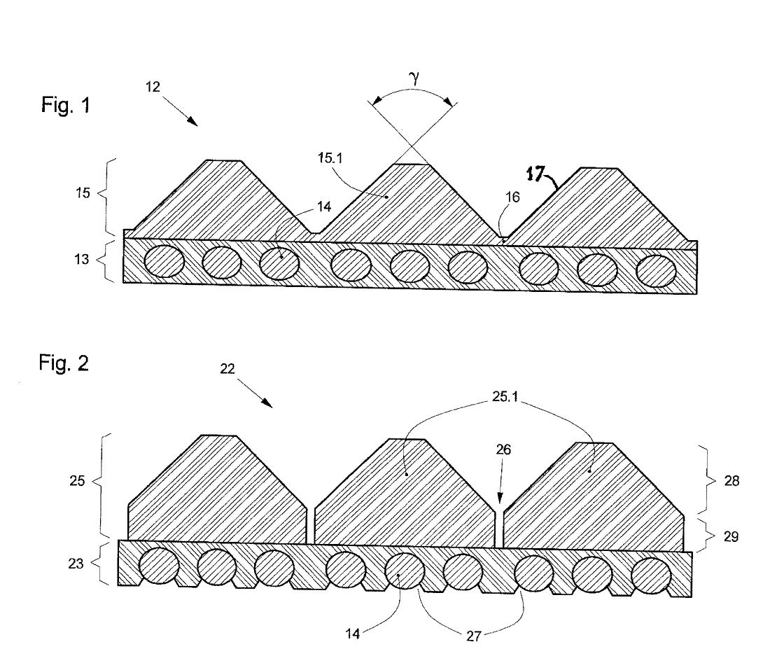

FIG. 1 shows a cross-section through a belt according to an embodiment of the present invention; and

FIG. 2 shows a section, which is parallel to a lift cage front, through a lift installation according to an embodiment of the present invention.

FIG. 1 shows a cross-section through a belt 12 according to an embodiment of the present invention. This comprises a first part belt 13 of a thermoplastic plastics material, in the example of embodiment polyamide. The first part belt 13 is produced by extrusion, wherein tensile carriers 14 consisting of multiply stranded steel wires are fed thereto during its production in such a manner that these are completely included and fixed in the finished first part belt 13. A second part belt 15 of an elastomer, in the example of embodiment polyurethane, is subsequently extruded onto the first part belt 13. In that case the side, which is remote from the first part belt, of the second part belt 15 is constructed as a traction surface which is provided for co-operation with a drive wheel 4.1 (see FIG. 2) having a wedge rib profile on its running surface. For this purpose the traction surface of the second part belt 15 has wedge ribs 15.1, the flanks of which include an angle γ of 90°. The wedge ribs 15.1 are connected together by relatively thin connecting webs 16 extending between adjacent ribs on the connecting surface between the two part belts, whereby the strength of the connection between the two part belts is increased.

In an embodiment, which is not illustrated, the traction surface is provided with a thin coating of polyamide in order to reduce the coefficient of friction. A sufficient traction capability nevertheless results due to the wedge ribs 15.1, wherein the polyamide coating advantageously reduces the wear of the traction surface and decreases the risk of jamming of the belt 12 in the drive wheel 4.1.

The size ratios between first and second part belt and the tensile carriers are illustrated (not to scale) in FIG. 1 for clarification of the individual elements. The first part belt 13 is, rather, actually thinner than the second part belt 15 and has a thickness which is just sufficient to completely enclose the tensile carriers 14 and to transmit the stresses, which are introduced by this, as homogeneously as possible to the second part belt. The belt 12, which consists of the thicker, but more elastic, second part belt 15 and the less elastic, but thinner, first part belt 13 is thus overall sufficiently elastic in order to snugly loop around the belt wheels 4.1, 4.2 and 4.3 (see FIG. 2).

FIG. 2 shows a cross-section through a belt 22 according to a further form of embodiment of the present invention. This similarly comprises a first part belt 23 of a thermoplastic plastics material and a second part belt 25 of an elastomer, which is extruded onto the first part belt 13 and forms a traction surface with several wedge ribs 25.1. By contrast to the belt 12 described in FIG. 1 the wedge ribs, in the case of the belt 22 illustrated in FIG. 2, have between their trapezium-shaped or wedge-shaped contact sections 28 and the first part belt 23 a substantially rectangular base section 29 which embraces at least 20% of the height of the entire second belt 25. The wedge ribs 25.1, i.e. their base sections 29, are completely separated from one another by intermediate spaces 26. Such a form of embodiment has the advantage that the trapezium-shaped or wedge-shaped contact sections 28 of the wedge ribs 25.1 are resiliently displaceable relative to one another transversely to the longitudinal direction of the belt 22 so that the wedge rib arrangement can overall adapt resiliently to the wedge rib profile, which is present, of a corresponding belt wheel in which the shape and/or the mutual spacings of the wedge ribs deviate within permissible limits from the shape or the spacings of the wedge ribs of the belt. This form of embodiment has advantages with respect to the traction capability between a drive wheel and the belt, the service life of the belt and the belt wheels as well as the noise output of the entire belt drive.

In FIG. 2 there is in addition shown a form of embodiment of the belt 22 in which the tensile carriers 14 are laid in grooves 27 of the first part belt 23, as already described in the foregoing. The grooves 27 have been so thermally deformed in the illustrated form of embodiment after insertion of the tensile carriers 14 that the tensile carriers are stably fixed in the first part belt.

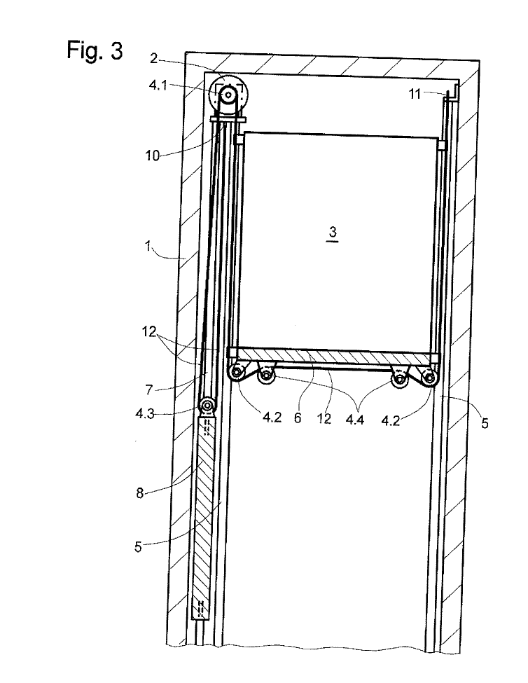

FIG. 3 schematically shows a section through a lift system, which is installed in a lift shaft 1, with the belt 12. The lift system comprises a drive unit 12, which is fixed in a lift shaft 1, with a drive wheel 4.1, a lift cage 3, which is guided at cage guide rails 5, with deflecting wheels mounted below the cage floor 6 and in the form of cage support rollers 4.2, a counterweight 8, which is guided at counterweight guide rails 7, with a further deflecting wheel in the form of a counterweight support roller 4.3, and the belt 12 for the lift cage 3 and the counterweight 8, which transmits the drive force from the drive wheel 4.1 of the drive unit 2 to the lift cage and the counterweight.

The belt 12 is fastened at one of its ends below the drive wheel 4.1 at a first belt fixing point 10. From this it extends downwardly to the counterweight roller 4.3, loops around this and extends from this to the drive wheel 4.1, loops around this and extends downwardly along the cage wall at the counterweight side, loops at both sides of the lift cage through 900 around respective cage support rollers 4.2 mounted below the lift cage 3 and extends upwardly along the cage wall remote from the counterweight 8 to a second belt fixing point 11.

The plane of the drive wheel 4.1 can be arranged at right angles to the cage wall at the counterweight side and its vertical projection can lie outside the vertical projection of the lift cage 3. It is therefore to be preferred that the drive wheel 4.1 has a small diameter, so that the spacing between the lefthand cage wall and the wall of the lift shaft 1 opposite thereto can be as small as possible. Moreover, a small drive wheel diameter enables use of a gearless drive motor with relatively small drive torque as drive unit 2.

The drive wheel 4.1 and the counterweight support roller 4.3 are provided at their periphery with grooves which are shaped to be substantially complementary to the ribs 15.1 of the belt 12. Where the belt 12 loops around one of the belt wheels 4.1 or 4.3 the ribs present on its traction surface lie in corresponding grooves of the belt wheel, whereby particularly good guidance of the belt on these drive wheels is ensured. Moreover, the traction capability is improved by the wedge action arising between the grooves of the belt wheel 4.1 serving as drive wheel and the ribs of the belt 12.

In a further form of embodiment (not illustrated) the slide surface of the belt 12 and the cage support rollers 4.2 also have corresponding wedge ribs. For this purpose, in the case of the further form of embodiment (not illustrated) a third part belt of polyurethane, which like the second part belt has wedge ribs, is arranged on the side of the first part belt 13 remote from the second part belt 15. By contrast to conventional lift installations a lateral guidance between the cage support rollers 4.2 and the belt 12 is therefore given in the looping around of the cage support rollers 4.2 below the lift cage 3, since the belt also has ribs on its side facing the cage support rollers 4.2. In order to still further improve the lateral guidance of the belt, two guide rollers 4.4 provided with grooves are mounted at the cage floor 6, the grooves of the rollers co-operating with the ribs of the belt 12 as lateral guidance.

1. Belt (12; 22) for a lift installation, which comprises:
a first part belt (13) of a first material;
a tensile carrier arrangement with at least one tensile carrier (14), which is arranged in the first part belt; and
a second part belt (15; 25) of a second material,
characterised in that the first material is a thermoplastic plastics material or contains a thermoplastic plastics material and the tensile carrier (14) consists of a single steel wire or of a steel wire strand or a steel wire cable.

2. Belt (12; 22) according to claim 1, wherein the first material is selected from one of the following material groups;
polyamide (PA), polyethylene (PE), polycarbonate (PC), polyvinylchloride (PVC) or
polyblend, which contains one of the above-mentioned materials or
fabric consisting of one of the said materials.

3. Belt (12; 22) according to claim 1 or 2, wherein the first material has at room temperature a minimum yield stress according to DIN 53455 or ISO 527 of 45 N/mm².

4. Belt (12; 22) according to any one of the preceding claims, wherein the first material has at room temperature a minimum elongation at tear according to DIN 53455 or ISO 527 of 45%.

5. Belt (12; 22) according to any one of the preceding claims, wherein the first material has at room temperature a minimum indentation hardness according to DIN 53456 or ISO 2039 (H358/30s) of 30 N/mm², preferably 50 N/mm², particularly preferably of 70 N/mm².

6. Belt (12; 22) according to any one of the preceding claims, wherein the thickness of the first part belt (13; 23) is at most 60%, preferably at most 40% and particularly preferably at most 30% of the total thickness of the belt.

7. Belt (12; 22) according to any one of the preceding claims, wherein the second part belt (15; 25) has a traction surface for co-operation with a drive wheel of the lift installation, in which at least one wedge rib (15.1; 25.1) is formed.

8. Belt (12; 22) according to any one of the preceding claims, wherein the traction surface of the second part belt (15) has for co-operation with a drive wheel (4.1) of the lift installation a coating which has a defined coefficient of friction relative to the running surface of the drive wheel (4.1), particularly a higher or lower coefficient of friction than the second material.

9. Belt (12; 22) according to any one of the preceding claims, wherein the second material comprises an elastomer, particularly polyurethane (PU), polychloroprene (CR) and/or ethylene-propylene-diene rubber (EPDM).

10. Belt (12; 22) according to any one of the preceding claims, wherein the second material has at room temperature a hardness of less than 95 Shore (A), preferably of less than 90 Shore (A) and particularly preferably a hardness of less than 85 Shore (A).

11. Belt (22) according to any one of the preceding claims, wherein
at least two wedge ribs (25.1) each have a trapezium-shaped or wedge-shaped contact section (28) and a substantially rectangular base section (29),
the rectangular base sections (29) are arranged between the contact sections (28) and the first part belt (23) and comprise at least 20% of the height of the second part belt (25) and
the base sections (29) are completely separated from one another by intermediate spaces (26).

12. Production method for a belt (12; 22) according to one of claims 1 to 11, comprising the steps:
producing the first part belt (13) from the first material, particularly by extrusion;
producing the second part belt (15) from the second material; and
connecting first part belt and second part belt.

13. Production method according to claim 12, wherein the second part belt is extruded onto the first part belt and/or thermally glued thereto.

14. Lift installation with a lift cage (3), a drive unit (2) with a drive wheel (4.1) and a belt arrangement with at least one belt (12; 22) according to any one of claims 1 to 11.
